(19) United States
(12) Patent Application Publication
(10) Pub. No.: US 2010/0046582 A1
(43) Pub. Date: Feb. 25, 2010

(54) Gigabit Spread-Spectrum Wireless Networking

(76) Inventor: Nathan Parker, Hot Springs, AR (US)

Correspondence Address: Mallard Computer, Inc.;Nathan Parker, President/CEO, 115 Wild Flower Trail, Demorest, GA, 30535, US

(21) Appl. No.: 12/197,185

(22) Filed: Aug. 22, 2008

(51) Int. Cl. H04B 1/00

(52) U.S. Cl. 375/132; 375/E01.033

(57) ABSTRACT

The patent of Nathan Parker on the related spectrum-sensing broadband modem/router is capable of producing gigabit transfer rates of data. However, none of the current wireless networking standards are capable of producing gigabit data transfer rates. This patent would allow this type of standard to exist, as well as produce the wireless cards that would take advantage of this new standard. The transmitter for this new standard would also be integrated into the spectrum-sensing broadband modem/router.

### RELATED APPLICATION

The present application is related to the application entitled “Spectrum-Sensing Broadband Modem/Router.”

### FIELD OF INVENTION

The invention relates to the field of wireless broadband communications and more precisely wireless networking.

### BACKGROUND OF INVENTION:

The patent of the “Spectrum-Sensing Broadband Modem/Router” allows for the capability of gigabit data transfer rates. This patent would officially allow a gigabit data transfer wireless standard to exist, as well as produce the equipment that would take advantage of this standard.

### SUMMARY OF INVENTION:

This invention would provide gigabit wireless data transfer rates used in a wireless network setup.

### BRIEF DESCRIPTION OF THE SEVERAL VIEWS OF THE DRAWINGS

Having generally described the invention, reference will now be made to the accompanying drawings, not drawn to scale, and wherein:

FIG. 1 provides a rough sketch of the various internal wireless cards that would be produced to take advantage of this new standard.

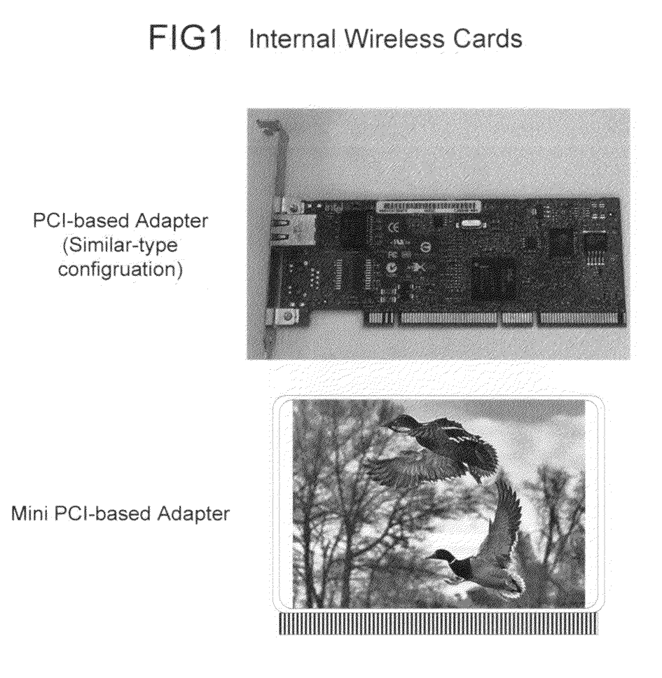

FIG. 2 provides a rough sketch of the various external wireless cards that would be produced to take advantage of this new standard.

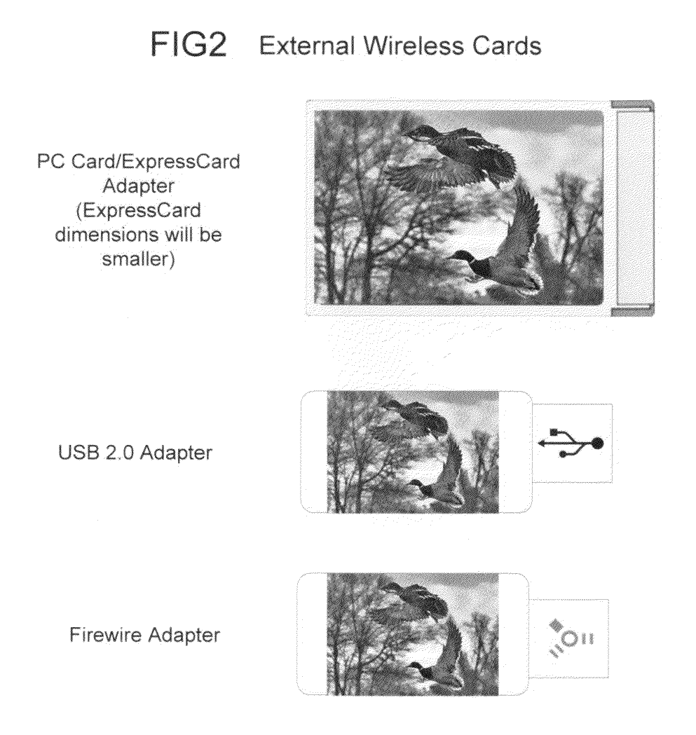

FIG. 3 provides the diagram of operation within a home network and while on the road.

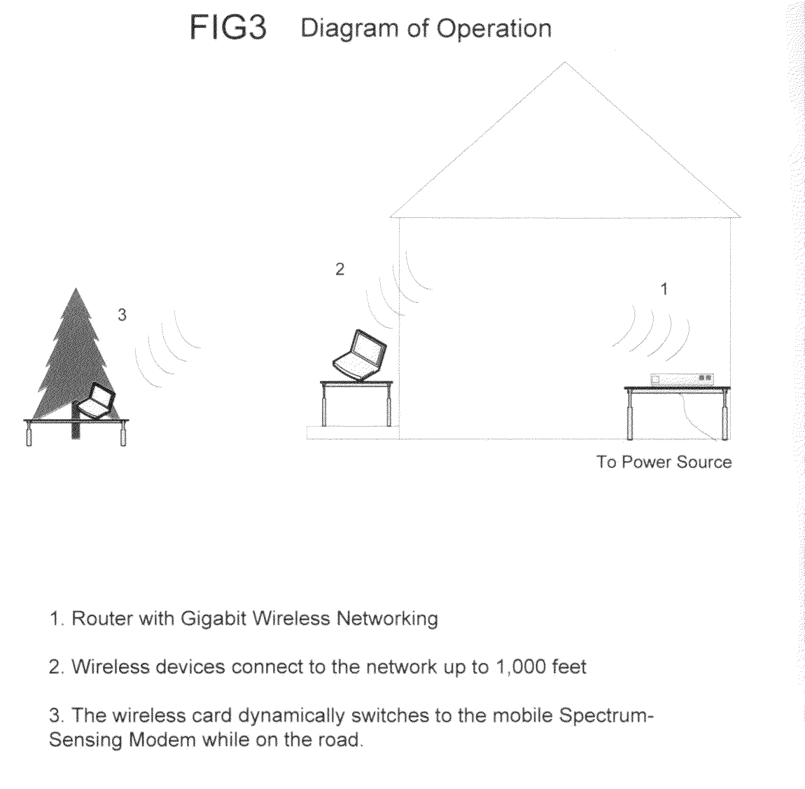

### DETAILED DESCRIPTION OF INVENTION:

The first goal of this invention will be to usher in a new standard for wireless connectivity. This new standard would provide wirelessly, to users, gigabit (GBPS) data transfer rates for both uploads and downloads. This would provide for much faster speeds than the megabit rates currently available using the Wi-Fi/802.11 standards. In addition, the radio communication would contain a frequency-hopping spread spectrum radio to provide for a virtually interference-free experience, and also contain an omni-directional tri-band antenna.

In addition, the signal would be powerful enough to be used in older structures where previous and current devices cannot penetrate. The wireless signal would also have a range of up to 1,000 feet per router, and routers could also be used as wireless repeaters to extend the network's range.

Eventually, this technology would be pre-installed on desktop and notebook computers and devices such as tablet computers, Personal Digital Assistants (PDA's), pocket computers, Blackberry devices, wireless/cellular phones, portable media players, televisions, television set-top boxes, remote controls, media center extenders, radios, game consoles, cars, digital cameras, memory cards, network video projectors, wireless picture frames, Internet appliances (such as the Chumby), and other devices that currently take advantage of Wi-Fi technology. Desktop and notebook computer users (as well as other device users) wishing to upgrade their current systems to take advantage of this technology could do so by purchasing a wireless card that can be installed in either a Peripheral Component Interconnect (PCI), Peripheral Component Interconnect Extended (PCI-X), Peripheral Component Interconnect Express (PCI-E), Mini Peripheral Component Interconnect (Mini PCI), Peripheral Component Interconnect Express Mini (PCI Express Mini), Personal Computer Memory Card International Association Card (PCMCIA/PC Card), ExpressCard, USB port, FireWire (IEEE1394), or other forms of peripheral connectivity. The cards would contain no visible exterior antennas and, with the exception of the PCI-based adapters, would contain a teal blue case with the official Mallard Computer, Inc., logo and product trademark on the top side. All cards would be manufactured from materials that are free from substances known to be hazardous to the health of consumers or detrimental to the environment. Dimensions would be specified to the relevancy of the type of card.

In addition, the wireless cards would also contain a mobile-optimized version of the spectrum-sensing modem. This would allow users to directly and securely access the television airwaves broadband anywhere they can receive a signal while on the road.

The device will automatically recognize when it is in the range of an accessible network and dynamically switch from the direct connection to sign onto the network. This would allow one to access the internet while on the road, then sign on to a network when back home, at the office, or at a public access point.

The device would also contain an integrated 802.11 a/b/g/n/y Wi-Fi adapter for accessing those networks as necessary. Additionally, the card would dynamically determine the fastest connection and connect to it, even to the point of connecting directly to the television airwaves broadband to access the Internet while still allowing file and printer sharing on the network.

Users will connect to the network via the network connection utility found in the notification area (Windows) or the Airport status menu (Macintosh), or the network connection utility of additional operating systems. Users will choose between “Wi-Net Base”, “Wi-Net Express”, or “Wi-Net Backup” for connecting to the network of one of their base stations, or “Wi-Net Mobile” for connecting directly to the television broadband airwaves. Users connecting to 802.11 based networks will simply choose the name of the 802.11 based network from the list.

That which is claimed:

1. A new wireless Internet standard that allows gigabit wireless data transfer rates.

2. The radio communication of claim 1 that would contain a frequency-hopping spread spectrum radio.

3. The radio communication of claim 1 that would contain an omni-directional tri-band antenna.

4. The radio communication of claim 1 that would be powerful enough to be used in older structures where current devices cannot penetrate.

5. The radio communication of claim 1 that would have a range of up to 1,000 feet per router.

6. Routers utilizing the radio communication of claim 1 that can also be used as wireless repeaters to extend the network's range.

7. The radio communication of claim 1 that can be pre-installed on desktop and notebook computers.

8. The radio communication of claim 1 that can be pre-installed on a variety of portable computer devices including tablet computers, Personal Digital Assistants (PDA's), pocket computers, Blackberry devices, wireless/cellular phones and portable media players.

9. The radio communication of claim 1 that can be pre-installed on a variety of other media devices including televisions, television set-top boxes, remote controls, media center extenders, radios, digital cameras, memory cards, game consoles, cars, network video projectors, wireless picture frames, Internet appliances (such as the Chumby) and other devices that currently take advantage of Wi-Fi technology.

10. A wireless card that can be installed in either a Peripheral Component Interconnect (PCI), Peripheral Component Interconnect Extended (PCI-X), Peripheral Component Interconnect Express (PCI-E), Mini Peripheral Component Interconnect (Mini PCI), Peripheral Component Interconnect Express Mini (PCI Express Mini), Personal Computer Memory Card International Association Card (PCMCIA/PC Card), ExpressCard, USB port, FireWire(IEEE1394), or other forms of peripheral connectivity.

11. The wireless card of claim 10 without visible exterior antennas.

12. The wireless card of claim 10 that will contain a mobile-optimized version of the spectrum-sensing modem.

13. The wireless card of claim 12 that will directly and securely access the television airwaves broadband at any location.

14. The wireless card of claim 12 that will automatically recognize when it is in the range of an accessible network.

15. The wireless card of claim 14 that will dynamically switch from the direct connection to sign onto the network.

16. The wireless card of claim 14 that allows one to access the internet while on the road, then sign on to a network when back home, at the office, or at a public access point.

17. The wireless card of claim 14 that contains an integrated 802.11 a/b/g/n/y Wi-Fi adapter for accessing those networks as necessary.

18. The wireless card of claim 14 that will dynamically determine the fastest connection and connect to it.

19. The wireless card of claim 18 that connects directly to the television airwaves broadband to access the Internet while still allowing file and printer sharing on the network.

20. The wireless card of claim 18 that will connect to the network via the network connection utility found in the notification area (Windows).

21. The wireless card of claim 18 that will alternatively connect to the network via the network connection utility found in the Airport status menu (Macintosh).

22. The wireless card of claim 18 that will alternatively connect to the network via the network connection utility of additional operating systems.

23. The wireless card of claim 18 that will allow users to choose between “Wi-Net Base”, “Wi-Net Express” or “Wi-Net Backup” for connecting to the network of one of their base stations.

24. The wireless card of claim 18 that will allow users to select “Wi-Net Mobile” for connecting directly to the television broadband airwaves.

25. The wireless card of claim 18 that will allow users to select the 802.11 based network from the list of available 802.11 based networks.
